(19) United States
(12) Patent Application Publication
(10) Pub. No.: US 2018/0279225 A1
(43) Pub. Date: Sep. 27, 2018

(54) COMMUNICATIONS DEVICE CONTROL SYSTEM

(71) Applicant: Jack William Harrison, Prebbleton (NZ)

(72) Inventor: Jack William Harrison, Prebbleton (NZ)

(21) Appl. No.: 15/763,620

(22) PCT Filed: Sep. 26, 2016
(86) PCT No.: PCT/IB2016/055724

§ 371 Date: Mar. 27, 2018

(30) Foreign Application Priority Data
Oct. 1, 2015 (NZ) 712912

(51) Int. Cl. H04W 52/02

(52) U.S. Cl. CPC H04W 52/0274

(57) ABSTRACT

A method of controlling at least one communications device on a wireless terminal, including the steps of: defining a primary operative period; switching on a primary communications device for the duration of the primary operative period; and switching off the primary communications device when the primary operative period has elapsed.

### TECHNICAL FIELD

The present invention relates to device management systems for communications devices in wireless terminals, such as mobile phones.

### BACKGROUND ART

Wireless terminals may connect to a network in order to transmit or receive information by use of a variety of communications devices, such as WLAN receivers or cellular phone connection units.

Applications running on the wireless terminal may periodically request a communications device to send a signal, for example to interrogate a server for updated data, or to backup or sync data from the wireless terminal to another device or server. This can occur even when the application is running in the background, with the wireless terminal in a stand-by mode.

This can result in large quantities of data being sent and received via the communications device. This can be disadvantageous to users who have paid for a set limit of data, and may unexpectedly find their data to have been quickly used up by background applications. Furthermore, communications devices are typically one of the highest energy consumers on the wireless terminal. Heavy use of a communications device can quickly deplete the available stored energy, decreasing battery life in the wireless terminal.

### DISCLOSURE OF INVENTION

It is an object of the present invention to provide a system for managing the activity of a communications device, so that the amount of energy and data bandwidth used by the communications device can be controlled, by controlling the amount of time the communications device is active.

Therefore the present invention provides a method of controlling at least one communications device on a wireless terminal, including the steps of:
defining a primary operative period;
switching on the communications device for the duration of the primary operative period; and
switching off the communications device when the primary operative period has elapsed.

In a preferred embodiment, the method further includes the steps of:
defining a primary inoperative period;
after the switching off step, leaving the communications device off for the duration of the primary inoperative period; and
repeating the switching on and switching off steps when the primary inoperative period has elapsed.

Preferably these steps are repeated as a continuous cycle.

In a further embodiment, the method further includes the steps of:
defining a start time;
defining an end time; and
repeating the switching on, switching off and leaving steps between the start time and the end time.

The present invention further provides a method of controlling at least one communications device on a wireless terminal, including the steps of:
defining a primary operative period;
defining at least one set time;
whenever one of the at least one set times is reached, switching on the communications device for the duration of the primary operative period; and
switching off the communications device when the primary operative period has elapsed.

In a preferred embodiment, the wireless terminal is equipped with at least two communications devices, each of which is configured to provide feedback as to whether communication is successfully established, and the method further includes the steps of:
defining one communications device as a primary communications device, and another as a secondary communications device;
switching on the primary communications device for the duration of the primary operative period; and
if, at any stage during the primary operative period, the primary communications device provides feedback that communication is not successfully established, switching off the primary communications device, and switching on the secondary communications device for at least the remainder of the primary operative period.

Preferably the operative period (and/or any other parameters) for the primary communications device and the secondary communications device may be independently defined.

Preferably the present invention may also include the steps of specifying conditions for override of the method. These conditions may include activation of specified programmes on the wireless terminal, or availability of a connection via a primary communications device.

Preferably the at least one communications device is configured to provide feedback as to whether communication is successfully established.

In a preferred embodiment, the wireless terminal is a mobile phone. Preferably at least one communications device is a cellular phone communications device.

### BRIEF DESCRIPTION OF THE DRAWINGS

By way of non-limiting example only, preferred embodiments of the invention are described in detail below with reference to the accompanying drawings, in which:

FIG. 1 is a block diagram showing an example of a configuration of a wireless terminal according to the present invention;

FIG. 2 is a diagram showing the steps of a preferred embodiment of the present invention;

FIG. 3 is a diagram showing the steps of a further embodiment of the present invention;

FIG. 4 is a diagram showing the steps of a further embodiment of the present invention;

FIG. 5 is a graph showing the switching cycle of a communications device operated in accordance with the embodiment of the present invention show in in FIG. 4;

FIG. 6 is a diagram showing the steps of an alternative embodiment of the present invention; and

FIG. 7 is a mock-up of a user interface for implementing the defining steps of the invention on an iPhone.

### BEST MODE(S) FOR CARRYING OUT THE INVENTION

Preferred embodiments of the present invention are described below, in which the wireless terminal is a mobile phone, and the communications device is a cellular phone communicating unit. It will be apparent to one skilled in the art how the present invention could be easily adapted to use by other wireless terminals equipped with different communications devices.

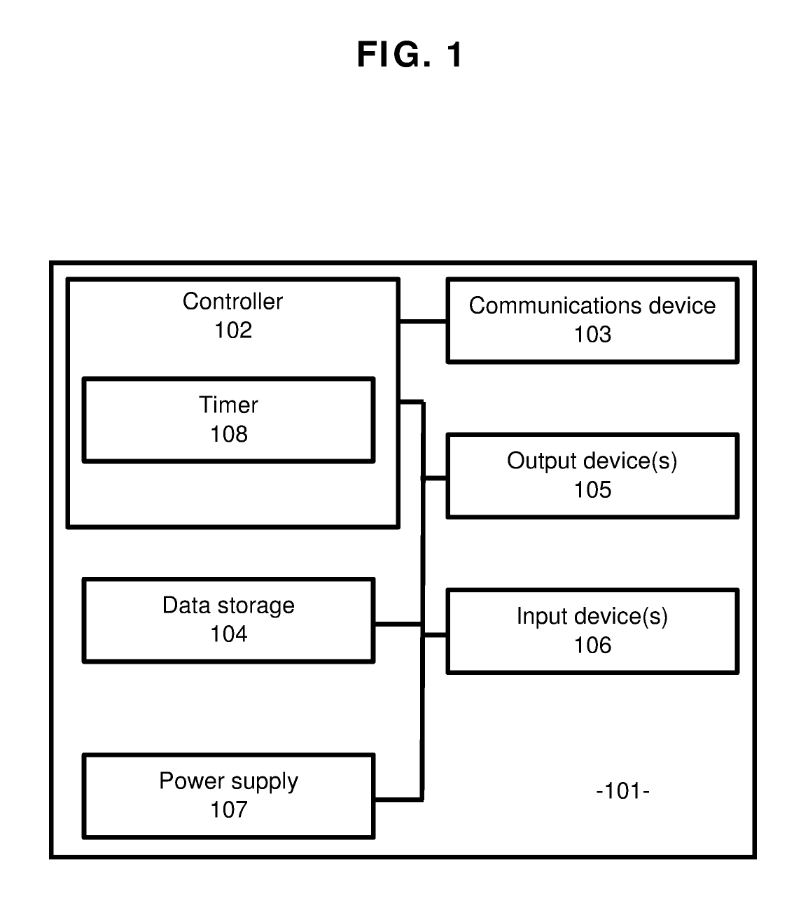

FIG. 1 is a block diagram showing an example of the configuration of a mobile phone 101 according to the first preferred embodiment of the invention. The mobile phone 101 includes a controller 102, a communications device 103, a data storage unit 104, at least one output device 105, at least one input device 106, and a power supply 107.

Controller 102 is connected to, and controls the activation of, communications device 103. In the embodiment shown, this is achieved by controller 102 being in the circuit between power supply 107 and communications device 103. Controller 102 includes a switch, by which power can be cut off from communications device 103 by controller 102. However, controller 102 could act to activate or deactivate communications device 103 according to any standard means.

Controller 102 includes a timer 108.

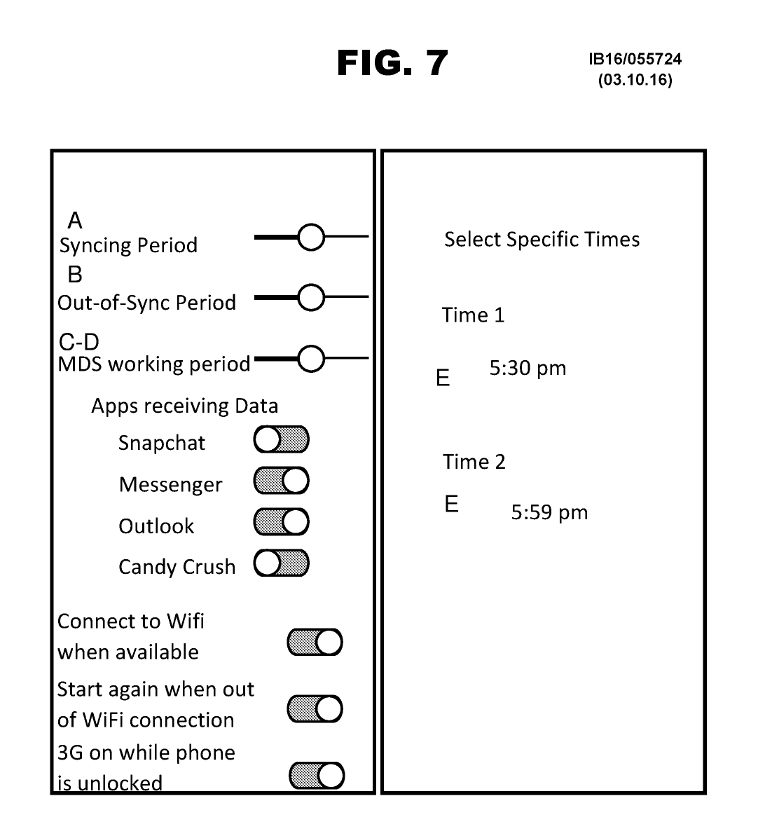

In this preferred embodiment, the controller 102 is operated in accordance with a programme stored in the data storage unit 104. According to the programme, at least one output device 105, such as a screen, is used to ask a user to input certain key parameters. These parameters are entered by a user through at least on input device 106, and stored in the data storage unit 104 as part of the programme. FIG. 7 shows an example of how an input device 106, being a touch screen, can be used to input and adjust various parameters for the programme.

A first, essential, parameter is the operative period A (labelled “Syncing Period”). Optionally, additional parameters for an inoperative period B (labelled “Out-of-Sync Period”), “Start Time” C and “End Time” D, may be provided. Alternatively, at least one “Fixed Time” E may be provided, together with Active Period A.

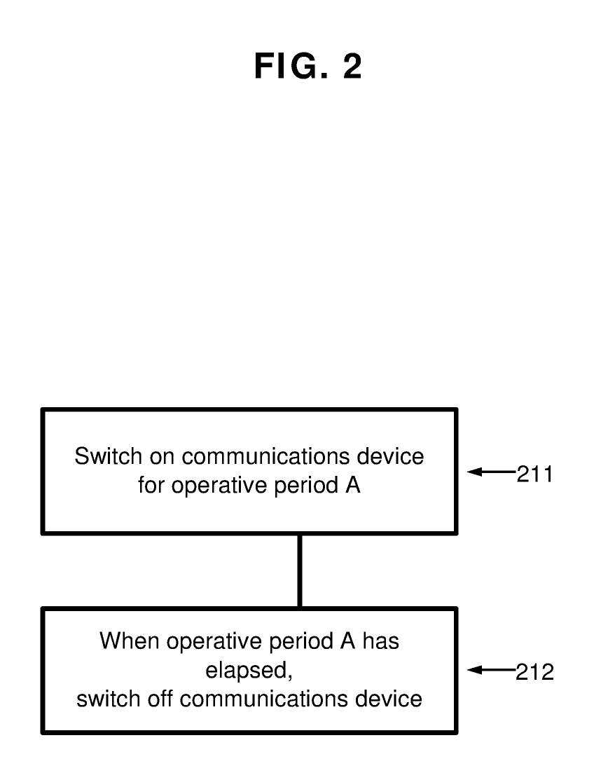

FIG. 2 illustrates the most basic embodiment of the present invention. At step 211, the controller 102 switches the communications device 103 on. The controller 102 then uses timer 108 to monitor the passing of time. At step 212, when the time elapsed matches the operative period A, the controller 102 switches the communications device 103 off.

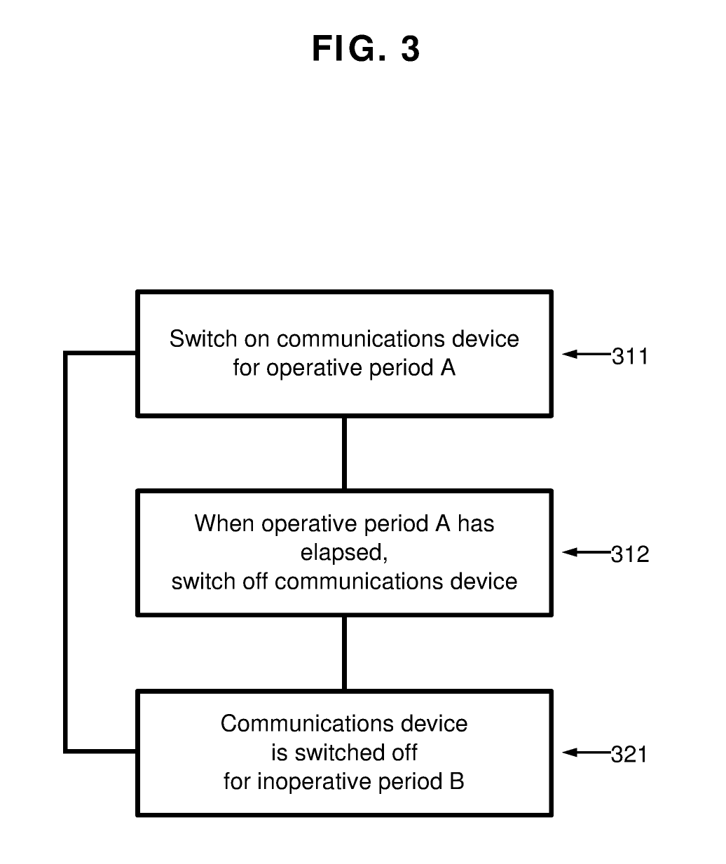

FIG. 3 illustrates a further embodiment of the present invention. The controller 102 uses timer 108 to monitor the passing of time. At step 311, the controller 102 switches the communications device 103 on. At step 312, when the time elapsed matches the operative period A, the controller 102 switches the communications device 103 off. At step 321, the communications device 103 remains switched off for the duration of inoperative period B. At the end of inoperative period B, steps 311, 312 and 321 are repeated.

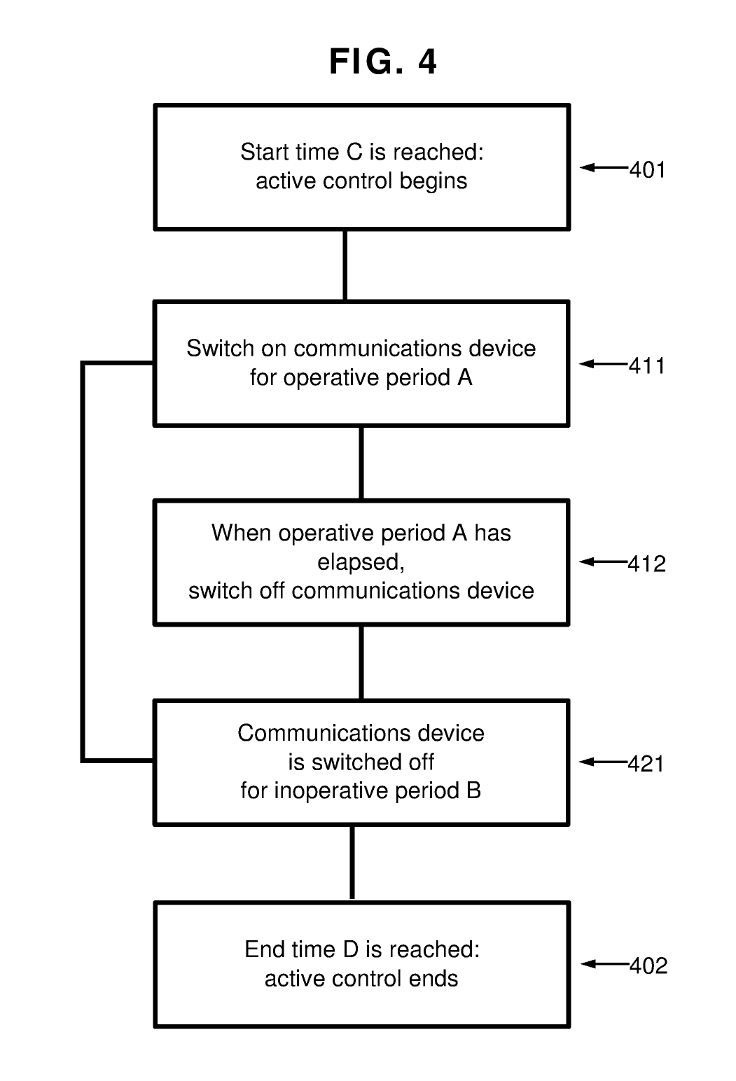

FIG. 4 illustrates a further embodiment of the present invention. The controller 102 uses timer 108 to monitor the passing of time. At step 401, when Start Time C is reached, the controller 102 begins active control of the communications device 103. At step 411, the controller 102 switches the communications device 103 on. At step 412, when the time elapsed matches the operative period A, the controller 102 switches the communications device 103 off. At step 421, the communications device 103 remains switched off for the duration of inoperative period B. At the end of inoperative period B, steps 411, 412 and 421 are repeated. This cycle repeats (or may occur less than one time), until step 402—when the End Time D is reached, the controller ends active control of the communications device 103, which is then switched off, regardless of what point in the cycle of steps 411, 412 and 421 has been reached.

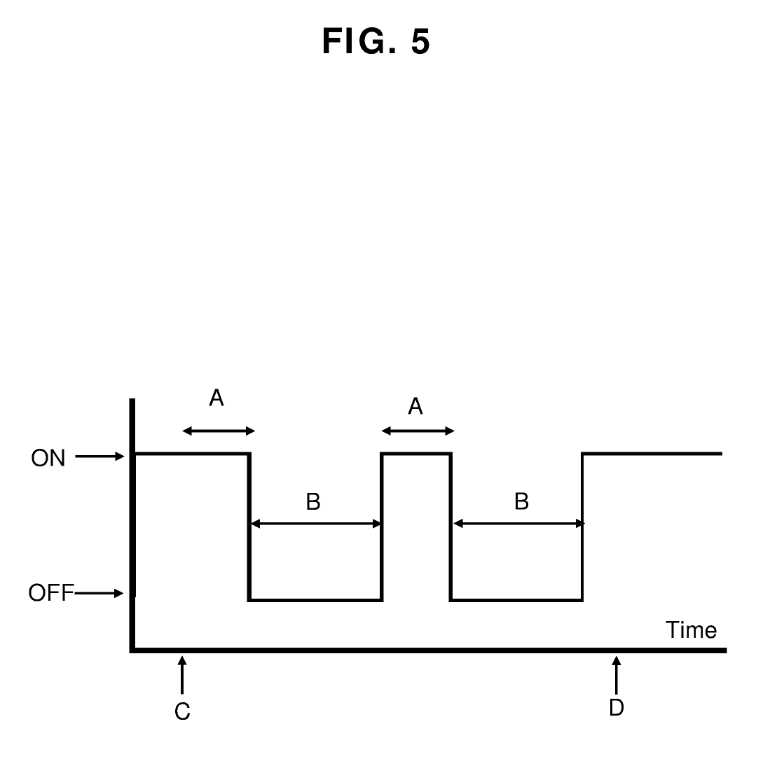

FIG. 5 shows the switching on and off of the communications device 103 by the controller 102 operating in accordance with the embodiment of the present invention described above with reference to FIG. 4. The communications device 103 is shown to be switched “On” when there is no active control of the communications device 103 by the controller. The present invention may optionally further provide for this “default” state to be specified by the user.

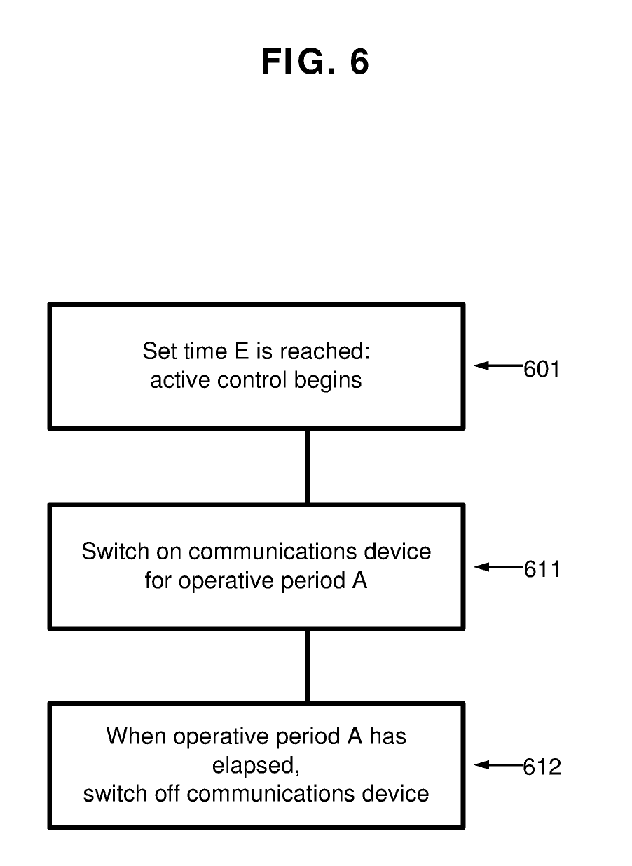

FIG. 6 illustrates an alternative embodiment. The controller 102 uses timer 108 to monitor the passing of time. At step 601, when Fixed Time E is reached, the controller 102 beings active control of the communications device 103. At step 611, the controller 102 switches the communications device 103 on. At step 612, when the time elapses matches the operative period A, the controller 102 switches the communications device 103 off.

The controller 102 may also be configured to allow an override of the defined parameters if certain conditions are met.

The communications device may be configured to provide feedback to the controller as to whether communication is successfully established. If the communications device is unable to establish a successful connection, it may be switched off, even though the operative period has not been completed.

The user may be able specify particular programmes or apps on the wireless terminal that are allowed to force the controller to turn on the communications device, regardless of whether the controller is in the operative period. For example, the controller may be configured so that if the user opens an email app, or a download service such as AppStore or iTunes, the communications device is immediately switched on, to allow syncing of remote data.

If there are multiple communications devices available, the user may be able to define a hierarchy. The communications devices may be configured to provide feedback to the controller as to whether communication is successfully established. If a primary communications device is unable to establish a successful connection, it may be switched off, and a secondary communications device switched on instead for the remainder of the syncing period. For example, in a mobile phone, connection via a WLAN connector may be set to be the primary communications device, and connection via a 3G or 4G cellular network may be a secondary device. This means that if the WLAN connector is able to connect to an available WiFi network, there is no need for activation of the cellular network connection device, but if the WiFi connection fails, the cellular network will be used instead, allowing syncing to occur as scheduled.

The user may optionally be able to specify different operative periods (or other parameters) for the different communications devices. For example, the operative period for a WiFi connection may be longer than the operative period for a cellular connection, to limit cellular data costs. In an alternative example, if a primary communications device is able to successfully establish communication, it may have an infinite operative period, with scheduled or limited activation applied to a secondary communications device only occurring when the primary communications device is unable to successfully connect. In a mobile phone, this configuration may allow an indefinite connection to a free WiFi network, with active control of a 3G of 4G cellular communications system occurring only when WiFi is unavailable.

The embodiments shown and described in detail herein are by way of example only. The present invention is intended to include such modifications and variations thereto as may be obvious to one skilled in the art.

1-4. (canceled)

5. A method of controlling at least one communications device on a wireless terminal, including the steps of:
defining a primary operative period;
switching on a primary communications device for the duration of the primary operative period; and
switching off the primary communications device when the primary operative period has elapsed,
defining a primary inoperative period;
after the switching off step, leaving the primary communications device off for the duration of the primary inoperative period;
repeating the switching on and switching off steps when the primary inoperative period has elapsed;
defining a start time;
defining an end time; and
repeating the switching on, switching off and leaving steps between the start time and the end time.

6. A method of controlling at least one communications device on a wireless terminal, including the steps of:
defining a primary operative period;
switching on a primary communications device for the duration of the primary operative period;
switching off the primary communications device when the primary operative period has elapsed; and
defining at least one set time;
wherein the switching on step occurs whenever one of the at least one set times is reached.

7. The method according to claim 5, wherein the primary communications device is configured to provide feedback as to whether communication is successfully established.

8. The method according to claim 7, wherein the wireless terminal is equipped with at least two communications devices, wherein if, at any stage during the primary operative period, the primary communications device provides feedback that communication is not successfully established, the method further includes the steps of:
switching off the primary communications device, and
switching on a secondary communications device for at least the remainder of the primary operative period.

9. The method according to claim 7, wherein the wireless terminal is equipped with at least two communications devices, further including the step of:
defining a secondary operative period;
wherein if, at any stage during the primary operative period, the primary communications device provides feedback that communication is not successfully established, the method further includes the steps of:
switching off the primary communications device, and
switching on a secondary communications device for the secondary operative period.

10. The method according to claim 5, further including the step of:
defining an override condition such that when the override condition is met, the method ends.

11. The method according to claim 10, wherein the override condition is the activation of a specified programme on the wireless terminal.

12. The method according to claim 5, wherein at least one communications device is a cellular communications device.

13. The method according to claim 5, wherein the wireless terminal is a mobile phone.

14. A wireless terminal including at least one communications device, configured to carry out the method according to claim 5.

15. The wireless terminal according to claim 14, wherein the wireless terminal is a mobile phone.

16. The method according to claim 6, wherein the primary communications device is configured to provide feedback as to whether communication is successfully established.

17. The method according to claim 16, wherein the wireless terminal is equipped with at least two communications devices, wherein if, at any stage during the primary operative period, the primary communications device provides feedback that communication is not successfully established, the method further includes the steps of:
switching off the primary communications device, and
switching on a secondary communications device for at least the remainder of the primary operative period.

18. The method according to claim 16, wherein the wireless terminal is equipped with at least two communications devices, further including the step of:
defining a secondary operative period;
wherein if, at any stage during the primary operative period, the primary communications device provides feedback that communication is not successfully established, the method further includes the steps of:
switching off the primary communications device, and
switching on a secondary communications device for the secondary operative period.

19. The method according to claim 6, further including the step of:
defining an override condition such that when the override condition is met, the method ends.

20. The method according to claim 19, wherein the override condition is the activation of a specified programme on the wireless terminal.

21. The method according to claim 6, wherein at least one communications device is a cellular communications device.

22. The method according to claim 6, wherein the wireless terminal is a mobile phone.

23. A wireless terminal including at least one communications device, configured to carry out the method according to claim 6.

24. The wireless terminal according to claim 23, wherein the wireless terminal is a mobile phone.

25. The method according to claim 8, further including the step of:
defining an override condition such that when the override condition is met, the method ends.

26. The method according to claim 9, further including the step of:
defining an override condition such that when the override condition is met, the method ends.

27. The method according to claim 17, further including the step of:
defining an override condition such that when the override condition is met, the method ends.

28. The method according to claim 18, further including the step of:
defining an override condition such that when the override condition is met, the method ends.

29. A wireless terminal including at least one communications device, configured to carry out the method according to claim 8.

30. A wireless terminal including at least one communications device, configured to carry out the method according to claim 9.

31. A wireless terminal including at least one communications device, configured to carry out the method according to claim 10.

32. A wireless terminal including at least one communications device, configured to carry out the method according to claim 17.

33. A wireless terminal including at least one communications device, configured to carry out the method according to claim 18.

34. A wireless terminal including at least one communications device, configured to carry out the method according to claim 19.
